(19) United States
(12) Patent Application Publication
(10) Pub. No.: US 2024/0208539 A1
(43) Pub. Date: Jun. 27, 2024

(54) COMPUTER-IMPLEMENTED METHOD AND SYSTEM FOR THE BEHAVIOR PLANNING OF AN AT LEAST PARTIALLY AUTOMATED EGO VEHICLE

(71) Applicant: Robert Bosch GmbH, Stuttgart (DE)

(72) Inventors: Johannes Christian Mueller, Ostelsheim (DE); Anne Von Vietinghoff, Renningen (DE); Christian Heinzemann, Vellmar (DE); Heiko Freienstein, Weil Der Stadt (DE); Jens Oehlerking, Stuttgart (DE); Martin Butz, Stuttgart (DE); Martin Herrmann, Korntal (DE); Michael Rittel, Markgroeningen (DE); Ralf Kohlhaas, Calw (DE); Stefan Ruppin, Grafenau (DE); Steffen Knoop, Hohenwettersbach (DE)

(21) Appl. No.: 18/530,546

(22) Filed: Dec. 6, 2023

(30) Foreign Application Priority Data
Dec. 22, 2022 (DE) 10 2022 214 267.5

(51) Int. Cl. B60W 60/00

(52) U.S. Cl. CPC B60W 60/0015; B60W 60/0013; B60W 2554/4046

(57) ABSTRACT

A computer-implemented method for the behavior planning of an at least partially automated EGO vehicle. The method uses a database of pre-defined partial situations and an evaluation model for each partial situation, as well as a pre-defined rule set for evaluating possible behaviors of the EGO vehicle in a given situation. The EGO vehicle performs: aggregating situation-specific information; generating an environment model of the given situation based on the situation-specific information; analyzing the environment model to identify at least one partial situation in the database; generating at least one instance for each identified partial situation; analyzing all generated instances by using the evaluation model of the respectively underlying partial situation to determine boundary conditions for the possible behaviors of the EGO vehicle in the given situation; prioritizing the possible behaviors of the EGO vehicle based on the boundary conditions determined in this way in conjunction with the rule set.

### CROSS REFERENCE

The present application claims the benefit under 35 U.S.C. § 119 of German Patent Application No. DE 10 2022 214 267.5 filed on Dec. 22, 2022, which is expressly incorporated herein by reference in its entirety.

### FIELD

The present invention relates to a computer-implemented method and a system for the behavior planning of an at least partially automated EGO vehicle.

A vehicle to which or for which the proposed method for behavior planning is applied is referred to below as an EGO vehicle.

### BACKGROUND INFORMATION

Such a method is described, for example, in U.S. Pat. No. 11,392,120. In particular, a rule set for the behavior of an at least partially automated vehicle and also its implementation in the form of logical expressions and logical relationships are described here. The individual rules in this rule set are based on social, cultural, legal, ethical, moral or other rules of behavior, principles or norms, such as, for example, traffic laws, traffic regulations, culturally conditioned rules of behavior in traffic, rules for the use of roads and other drivable areas, preferred driving styles, pedestrian behavior, and driving experiences. The rule set provides a classification of the rules into priority classes according to their importance or significance. In this way, the rules of the rule set can be prioritized amongst one another. For example, individual rules can always, or even only in certain cases, be given priority over other rules, depending on the importance or significance of the rules concerned in a given traffic situation. According to U.S. Pat. No. 11,392,120, a deviation from the rules of the rule set is determined and quantitatively evaluated with the aid of a metric (deviation metric) not specified in greater detail, wherein this metric is used here to evaluate vehicle trajectories. Each trajectory proposal is thus initially evaluated individually in order to then select and implement the trajectory proposal which, as determined in the metric, deviates the least from the rules of the rule set.

In practice, the procedure described by U.S. Pat. No. 11,392,120 proves to be problematic in several respects.

U.S. Pat. No. 11,392,120 pursues a sampling-based approach, according to which possible behaviors of the vehicle are always first detailed in the form of trajectory proposals. Only then are the trajectory proposals evaluated. The detailing of all trajectory proposals is associated with a comparatively high computational effort.

According to U.S. Pat. No. 11,392,120, the trajectory proposals are evaluated with the aid of the rule set, individually and independently of one another. This evaluation is based on a pre-specified metric for the deviation from the rules of the rule set and therefore depends significantly on the particular definition of this metric. In this context, it is particularly problematic that such a metric-based evaluation does not allow any conclusions at all to be drawn about the rules that may have been infringed or complied with.

According to U.S. Pat. No. 11,392,120, the evaluation is used to select a trajectory proposal which should then be used as a basis for automated vehicle control. A ranking of the individual trajectory proposals or of possible behaviors is not provided. A list of possible behaviors sorted by priorities could, however, be advantageous, for example, for identifying fallback solutions if a higher-prioritized behavior cannot be realized.

In the paper M. Butz et al., “SOCA: Domain Analysis for Highly Automated Driving Systems,” 2020 IEEE 23rd International Conference on Intelligent Transportation Systems (ITSC), 2020, pp. 1-6, doi: 10.1109/ITSC45102.2020.9294438., the so-called SOCA method is presented. With the aid of the SOCA method, traffic situations are analyzed, with the aim of determining boundary conditions for or requirements for the behavior of an automated EGO vehicle in the particular traffic situation. For this purpose, firstly an abstract description of the traffic situation to be analyzed is generated. This description uses so-called zone graphs. A zone graph abstracts the traffic situation to be analyzed by representing the real road situation by a corresponding abstract traffic infrastructure element (static road geometry) having different zones that are relevant for the driving intention of the EGO vehicle but are initially specified neither with regard to their size nor with regard to their position. The different zones can represent different map regions, possible traffic flows, objects, etc. On the basis of this abstract description of the traffic situation, the possible developments or the behavior of the road users involved are then determined and morphologically analyzed in order to determine boundary conditions for the behavior of the EGO vehicle in the analyzed traffic situation.

It is noteworthy that the results or boundary conditions obtained in this way initially apply to all traffic situations with the same zone graph. A specification is not performed until the results are data-loaded with the situation-specific parameters of the analyzed traffic situation.

### SUMMARY

The present invention provides measures for simplifying the behavior planning of automated vehicles.

A computer-implemented method according to the present invention for the behavior planning of an at least partially automated EGO vehicle uses for this purpose a database of pre-defined partial situations and at least one evaluation model for each of these partial situations, as well as a pre-defined rule set for evaluating possible behaviors of the EGO vehicle in a given situation.

According to an example embodiment of the present invention, the EGO vehicle performs at least the following method steps:
a. collecting and/or retrieving situation-specific information from the vehicle's own information sources and from information sources outside the vehicle,
b. generating an environment model of the given situation on the basis of the situation-specific information,
c. analyzing the environment model in order to identify at least one partial situation in the database,
d. with the aid of the situation-specific information, generating at least one instance for each identified partial situation,
e. analyzing all generated instances using the at least one evaluation model of the respectively underlying partial situation in order to determine boundary conditions for the possible behaviors of the EGO vehicle in the given situation,
f. prioritizing the possible behaviors of the EGO vehicle on the basis of the boundary conditions determined in this way in conjunction with the rule set.

The present invention is based on the experience that complex traffic situations can generally be decomposed into simpler partial situations which, for example, comprise only partial regions of the overall situation or even just a selection of the road users in the overall situation. Experience has shown that the behavioral decisions made for such partial situations are often also appropriate in the context of the overall situation.

According to the present invention, it has been recognized that decomposing an overall situation into partial situations can be continued until the decomposition only comprises comparatively generic partial situations from a manageable, finite set of such generic partial situations.

Proceeding from this, it is provided according to an example embodiment of the present invention to decompose a given (traffic) situation into pre-defined and analyzed partial situations in order to use existing knowledge about possible behaviors in the individual partial situations for behavior planning in the given situation.

For this purpose, situation-specific information is aggregated first in order to generate an environment model of the given situation. The decomposition of the given situation into partial situations is effected by analyzing the environment model. The partial situations identified thereby are then instantiated by being data-loaded with the situation-specific information in order to specify the partial situations according to the given situation. According to an example embodiment of the present invention, the instantiated partial situations are analyzed independently of one another, wherein the evaluation models of the respectively underlying partial situation are used. The analysis results for the individual instantiated partial situations are then combined in order to determine boundary conditions for the possible behaviors of the EGO vehicle in the given situation. It is essential that the method according to an example embodiment of the present invention at this stage of the behavior planning provides only the determination of boundary conditions for the possible behaviors of the EGO vehicle. The detailing of one or even a plurality of possible behaviors can also take place only at a later point in time.

According to an example embodiment of the present invention, the prioritization of the possible behaviors of the EGO vehicle also takes place on the basis of the boundary conditions determined in this way. For this purpose, the boundary conditions for the individual behaviors are compared with the rules of the rule set, i.e., it is checked which rules of the rule set are complied with by a behavior with the given boundary conditions and which rules are infringed.

Within the scope of the present invention, in principle very differently defined partial situations and evaluation models implemented in different ways can be used. Accordingly, there are also different possibilities for compiling the database of pre-defined partial situations and corresponding evaluation models.

In a preferred variant of the method according to the present invention, each partial situation is defined as a situation class which is at least partially determined by at least one of the following elements: the EGO vehicle, at least one traffic infrastructure element, at least one other road user, and a general situation context. This definition of a partial situation is explained in more detail in conjunction with FIG. 2. Such a partial situation can be instantiated simply by being data-loaded with situation-specific information.

According to an example embodiment of the present invention, it is particularly advantageous if the pre-defined partial situations of the database are selected such that an environment model generated on the basis of situation-specific information can be represented by a composition of instantiated partial situations of the database. The database of the pre-defined partial situations should thus be combined as far as possible in such a way that many different traffic situations, and in particular the most frequent traffic situations, can be completely decomposed into partial situations of the database. The partial situations should on the one hand be so generic that they occur in as many different traffic situations as possible, but on the other hand also be so specific that the associated evaluation model has a certain informative value.

A very effective method for analyzing traffic situations with the aim of determining boundary conditions for the behavior of an automated EGO vehicle in the relevant traffic situation is the SOCA method described at the outset. The SOCA method is also suitable for generating evaluation models for the partial situations, which are then advantageously used within the scope of the method according to an example embodiment of the present invention. In this case, the evaluation models are based on a decomposition of the relevant partial situation into zone graphs and on a morphological behavior analysis of the road users involved. A particular advantage of the SOCA method is that, from the evaluation models generated in this way, formalized safety reasoning for the corresponding partial situations and also for their compositions can be derived.

In practice, some partial situations, or instances of partial situations, will interact and may even be mutually exclusive. These local interactions are advantageously already taken into account when combining the analysis results of the individual instantiated partial situations if at least some of the evaluation models comprise combination rules for combining the relevant partial situation with further partial situations.

As is already the case with the partial situations and the database of partial situations, the rule set used within the scope of the present invention can also be defined in very different ways. Thus, the rule set can be defined, for example, according to U.S. Pat. No. 11,392,120, which was discussed above. Since the rule set is used in most cases to substantiate the safety of the behavior planning, in a preferred embodiment of the present invention the pre-defined rule set comprises and prioritizes safety requirements and/or traffic regulations. Furthermore, it can comprise and prioritize comfort requirements and/or vehicle-related boundary conditions.

As already mentioned above, within the scope of the method according to the present invention, each individual partial situation identified in the given situation or each individual instance generated therefrom is analyzed separately in order to determine the possible behaviors of the EGO vehicle for the particular instance. For this purpose, the boundary conditions that the EGO vehicle should satisfy in the particular instance are determined. These boundary conditions are referred to here as instance boundary conditions. For determining the respective instance boundary conditions, the evaluation model and the situation context of the underlying partial situation are used, i.e., the evaluation model for the abstract partial situation is data-loaded with the situation-specific information and is thus specified for the particular instance.

According to an example embodiment of the present invention, it proves particularly advantageous if the boundary conditions for the possible behaviors of the EGO vehicle in the given situation can be determined by combining at least some of the generated instance boundary conditions. Such a combination will provide acceptable results at least when the given situation has been completely decomposed into partial situations, i.e. corresponds to the composition of the identified partial situations. Advantageously, when the instance boundary conditions are combined, any combination rules of the underlying evaluation models are already taken into account. In this way, the number of behaviors determined to be possible can already be meaningfully limited even before the prioritization.

In a particularly advantageous variant of the method according to the present invention, the prioritization of the possible behaviors of the EGO vehicle provides a ranking of the possible behaviors, i.e. a list of the possible behaviors sorted by priorities. Such a list can easily be created by comparing the respective boundary conditions of each of the possible behaviors of the EGO vehicle with the rules of the rule set. For this purpose, for each possible behavior defined by the respective boundary conditions, it is checked which rules of the rule set are complied with these boundary conditions and which rules are infringed. Given a suitable definition of the rules of the rule set, a sorting of the possible behaviors can thus be generated without a separate metric being required for this purpose.

According to an example embodiment of the present invention, it is particularly advantageous, in particular for safety reasoning regarding the behavior planning, if the comparison of the boundary conditions for the possible behaviors of the EGO vehicle with the rules of the rule set is logged. In this case, the selection of a possible behavior for controlling the EGO vehicle is completely transparent and is comprehensible at any time.

As already mentioned above, the method according to the present invention requires only the determination of boundary conditions in order to define the possible behaviors of the EGO vehicle. The detailing of one or even a plurality of possible behaviors can also take place only at a later point in time. The possible behaviors of the EGO vehicle in the given situation can also be defined by a set of behavior instructions that implement at least some of the determined boundary conditions, or also by a reference trajectory that satisfies at least some of the boundary conditions determined in this way. This variant is explained in more detail in conjunction with FIG. 7.

A particular advantage of the method according to the present invention is that a possible behavior of the EGO vehicle to be implemented in the given situation only needs to be detailed and/or optimized with respect to a prespecified quality function after the prioritization of the behavior previously determined as possible. This contributes to considerable savings in computational effort for behavior planning and control of the EGO vehicle.

### BRIEF DESCRIPTION OF THE DRAWINGS

FIG. 1 shows a block diagram with a computer-implemented system according to an example embodiment of the present invention for the behavior planning of an at least partially automated EGO vehicle.

FIG. 2 illustrates a partial situation within the scope of a computer-implemented method according to an example embodiment of the present invention for behavior planning.

FIG. 3 illustrates the identification of partial situations in an example situation according to one embodiment of the method according to the present invention.

FIG. 4 illustrates the instantiation of the partial situations identified in the example situation.

FIG. 5 illustrates the analysis of the instances generated in this way and the determination of instance boundary conditions for the possible behaviors of the EGO vehicle in the individual instances of the partial situations, according to an example embodiment of the present invention.

FIG. 6 illustrates the combination of the instance boundary conditions for determining boundary conditions for the possible behaviors of the EGO vehicle in the example situation, according to an example embodiment of the present invention.

FIG. 7 illustrates the use of the boundary conditions determined in this way for trajectory proposals for the EGO vehicle in the example situation, according to an example embodiment of the present invention.

FIG. 8 illustrates a priority synthesis for the example situation according to the method according to an example embodiment of the present invention.

### DETAILED DESCRIPTION OF EXAMPLE EMBODIMENTS

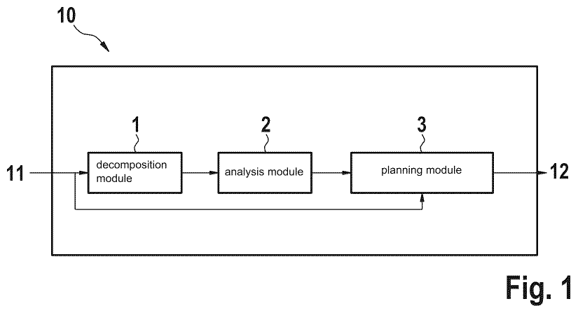

The block diagram in FIG. 1 illustrates the mode of operation of a computer-implemented system according to the present invention for the behavior planning of an at least partially automated EGO vehicle.

The system according to the present invention comprises a perception module for aggregating situation-specific information from the vehicle's own information sources and from information sources outside the vehicle, here not shown separately, and an evaluation module for generating an environment model 11 of the given situation on the basis of the situation-specific information, which is likewise not shown here separately.

An essential component of the system according to the present invention is a decomposition module 1, which analyzes the environment model 11 of a given situation. The decomposition module 1 has access to a database in which pre-defined partial situations and at least one evaluation model for each of these partial situations are stored. This database is not shown separately here as a functional component of the decomposition module 1. A given situation is decomposed into partial situations with the aid of the decomposition module 1. For this purpose, the environment model 11 of the given situation is analyzed in order to identify at least one partial situation in the database in the given situation. In addition, the decomposition module 1 identifies the instances of the identified partial situations relevant for the given situation and generates these instances by data-loading the corresponding partial situations with situation-specific information.

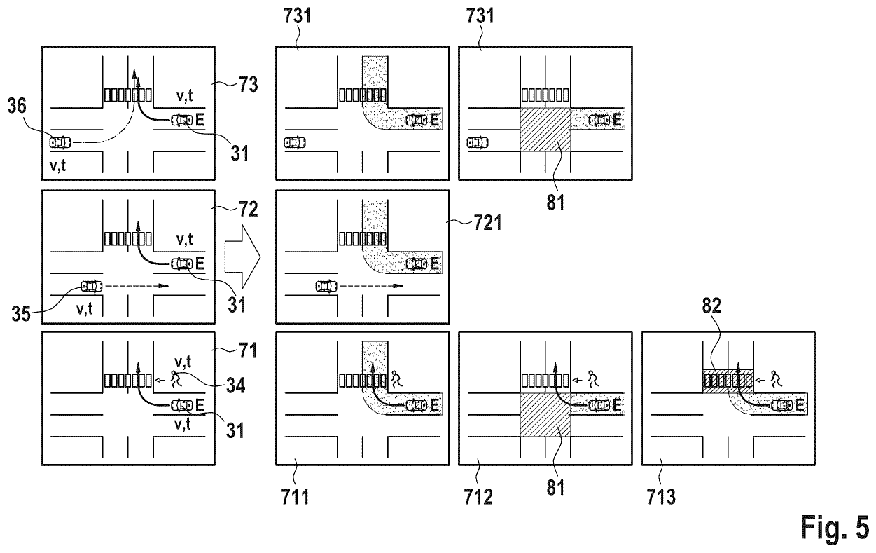

As a further essential component, the system according to the present invention comprises an analysis module 2 for determining boundary conditions for possible behaviors of the EGO vehicle in the given situation. For this purpose, using the at least one evaluation model of the respectively underlying partial situation, the analysis module 2 analyzes all generated instances. The analysis module 2 combines the results of these “individual” analyses and evaluates the overall result with the aid of a pre-defined rule set. In this way, the analysis module 2 performs a so-called priority synthesis, which is explained in more detail below in conjunction with FIGS. 5, 6 and 8. This priority synthesis has the goal of generating a list, sorted by priorities, of the behaviors possible for the EGO vehicle in the given situation.

This list is forwarded to a downstream planning module 3, which can then select one or more behaviors from the list, sorted by priorities, for controlling the EGO vehicle. If these behaviors are initially defined only by boundary conditions, the planning module 3 will need to detail the selected behaviors for the control, for example in the form of trajectories 12.

The system 10 shown in FIG. 1 thus consists of three components:

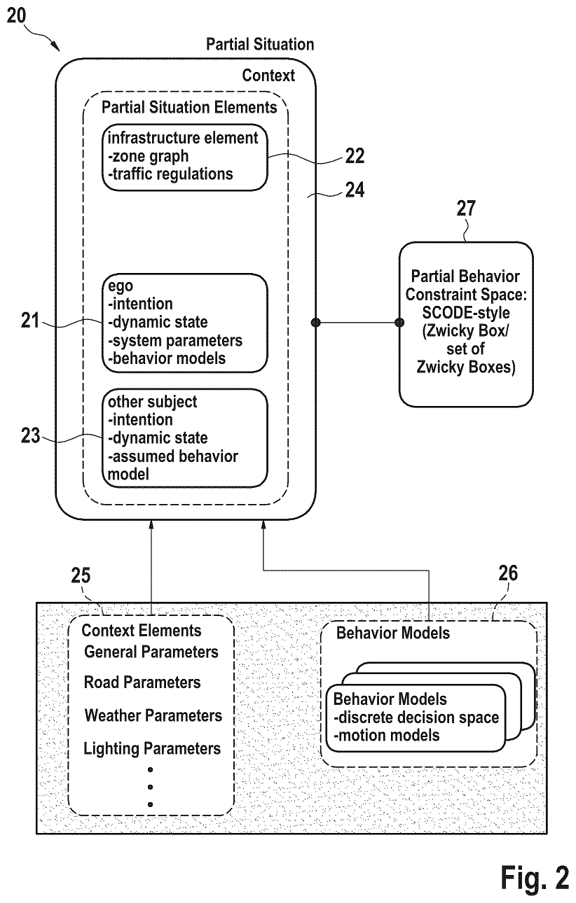

The decomposition module 1 returns the current traffic situation to a composition of a finite set of simpler situations, the so-called partial situations, on the basis of the environment model 11. The structure and function of a partial situation are described below in more detail in conjunction with FIG. 2. According to the present invention, these partial situations are analyzed individually and in composition in advance, off-line, for example with the aid of the SOCA approach, in order to generate evaluation models which the analysis module 2 can then access on-line. On the basis of these evaluation models, a general safety reasoning for the partial situations and their compositions can be derived and formalized in a rule set. In this way, it can be formally guaranteed that the vehicle behaves in the way that is most appropriate to the situation perceived by the vehicle.

The analysis module 2 derives a set of possible behaviors from the composition of the partial situations. A possible behavior can be represented, for example, by a set of boundary conditions, a set of behavior instructions, or a reference trajectory. For the priority synthesis, the analysis module 2 analyzes the possible behaviors as regards the partial situations. For this purpose, the analysis module 2 uses the previously generated evaluation models of the individual partial situations. The possible behaviors are then prioritized on the basis of the analysis results in combination with the rule set. This prioritization of the possible behaviors takes place automatically and is performed dynamically at runtime. In addition, the prioritization enables an efficient allocation of computing resources.

The planning module 3 usually selects only one or even a plurality of prioritized behaviors in order to detail and optimize them. In addition, the planning module 3 checks whether the detailed solution meets all the boundary conditions set for it. In general, the planning module 3 selects, as a solution, the possible behavior which meets all boundary conditions and is the most highly prioritized. If a plurality of behaviors have the same priority, the solution will be output which is best in terms of an optimality criterion.

As a result, if this is possible, a safer behavior is enforced while observing all the boundary conditions. And even if compliance with all boundary conditions is no longer possible, a solution can still be provided which least infringes the applicable boundary conditions. These boundary conditions can be strict, such as “stop in front of the traffic lights”, but also comparatively soft, such as “pass the obstacle instead of staying stationary”. The explication of the boundary conditions—not only of those which could be complied with but also of those which were not complied with—makes it possible to understand and justify a driving decision that has been made.

In one embodiment of the present invention, the planning module uses a graph search (e.g., Hybrid A* algorithm) in order to detail a behavior shown as a set of boundary conditions, and to optimize the solution found with regard to a quality function. The solution is checked for compliance with all boundary conditions in order to thus verify the validity of the solution. The planning module then outputs a trajectory which corresponds to the behavior with highest priority that is valid. If there are several behaviors of the same priority, the trajectory which is optimal with regard to the quality function will be output.

At this point, it should be expressly pointed out that the architecture of the system 10 shown in FIG. 1 and its components can be varied. For example, the possible behaviors of the EGO vehicle can alternatively also be made available by the planning module or a special generator module. In addition, there is also the possibility of providing a separate module for each of the individual method steps or of combining the decomposition and the priority synthesis in a single module.

FIG. 2 illustrates the concept of a partial situation and its use within the scope of the present invention. The present partial situation is a situation class which is described abstractly by certain properties or elements. The description of the partial situation 20 shown here substantially comprises three elements: the EGO vehicle 21, an abstract traffic infrastructure element 22, and a further road user 23. Each of these three elements is characterized by models, rules, state parameters, and/or state variables. In this case, the EGO vehicle is characterized by its driving intention, dynamic state variables, such as speed, acceleration and orientation, system parameters, such as technical vehicle parameters, and a behavior model, such as defensive driving or sporty driving. The abstract traffic infrastructure element 22 could be, for example, an intersection, a road junction or a road section. It is characterized here by a zone graph according to the SOCA method and by the traffic regulations applicable to this traffic infrastructure element, i.e., for example, “right before left”. The further road user 23 is likewise characterized here by his “movement” intention and by dynamic state variables as well as by a behavior model with which assumptions can be made for the behavior of the further road user. The elements 21, 22 and 23 are embedded in a general situation context 24, into which not only general parameters 25 but also general behavior models 26 of road users flow. Road state parameters, weather parameters and lighting parameters are mentioned here as examples of general context parameters. The general behavior models 26 could comprise motion models for classes of road users, such as pedestrians, cyclists, motorcyclists, car drivers, etc., and possibly model interactions between road users. The behavior models can be modeled, for example, by continuous motion models in the form of differential equations, by Markov decision processes or by discrete behavior spaces (discrete decision spaces).

A partial situation 20 defined in this way can be instantiated by being data-loaded with situation-specific information, i.e. configured corresponding to a given situation.

In one embodiment of the present invention, the motion models for describing the other road users are divided into different categories, for example into the three categories of uncooperative, expected and cooperative behavior. First, expected behavior is assumed for all road users except the EGO vehicle. For the prediction of the expected behavior, for example, the output of a multi-trajectory prediction network, as described in [Strohbeck et al. (2020)], can be used. Due to the multimodality of the prediction, this generates a combinatoric system of possibilities which, however, can already be strongly thinned out with the aid of a dependency tree. Such a dependency tree represents the dependency relations of the road users, e.g. on the basis of physical dependencies, traffic regulations, or on the basis of heuristics. In this way, firstly a possible behavior is selected for the road user who is at the beginning of the dependency chain along a dependency graph, i.e. on whom the other road users depend. For all subsequent road users, only those behaviors are then permitted that are permissible under the condition of the behaviors of the road users that are further ahead in the dependency chain.

In addition to the expected behaviors, uncooperative behavior is also investigated for the road users on whom the EGO vehicle is dependent. Accordingly, behaviors of the EGO vehicle which are safe even under the assumption of uncooperative behavior on the part of priority-entitled road users are prioritized, and behaviors which are safe only in the case of expected behavior are already used as the first fallback level. Behaviors that require a cooperative behavior on the part of vehicles which have right of way serve as a further fallback level. However, such behaviors are used only in emergencies.

By contrast, a cooperative behavior model is additionally applied for road users who must grant priority to the EGO vehicle. The expected behavior is compared with the cooperative behavior. If these are consistent, cooperative behavior will be assumed for the dependent vehicles, so that they can be ignored. However, if inconsistencies between the expected and the cooperative behavior model make it likely that a subordinate road user is not complying with the traffic regulations and thus can become a danger to the EGO vehicle, then behaviors of the EGO vehicle which, taking into account a corresponding infringement of the regulations or assuming an uncooperative model in relation to this road user, nevertheless are safe are upwardly prioritized.

The partial situation 20 was analyzed with the aid of the SOCA method. An evaluation model 27 was thus generated, which can be used as a basis for the analysis of all instances of the partial situation 20, for example in the form of Zwicky boxes. The correspondingly data-loaded evaluation model 27 then provides instance boundary conditions for possible behaviors of the EGO vehicle in the particular instance.

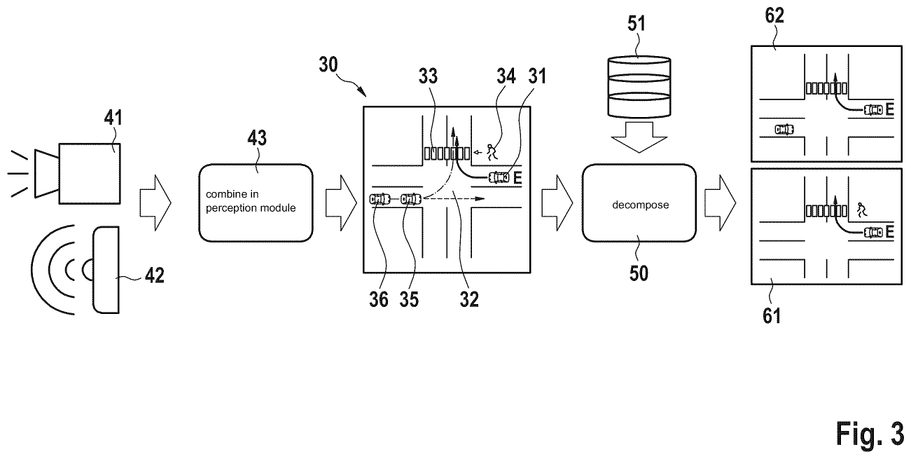

FIG. 3 illustrates the decomposition according to the present invention of an example situation 30 into partial situations.

In the example situation 30, the EGO vehicle 31 is approaching the intersection zone 32 of an intersection from the right or the east with the driving intention of turning off to the right, i.e. north. To do so, the EGO vehicle 31 must drive over a pedestrian crosswalk marked with white stripes 33 on the northbound roadway. A pedestrian 34 is approaching the crosswalk 33 from the east with the intention of crossing the roadway. In addition, two further vehicles 35 and 36 are approaching the intersection zone 32 from the west. The two vehicles 35 and 36 are traveling one behind the other on the same roadway, so that the vehicle 35 reaches the intersection zone 32 earlier. Vehicle 35 intends to drive over the intersection in the eastward direction, i.e. to drive straight ahead, while vehicle 36 intends to turn off to the left, i.e. to the north.

The EGO vehicle 31 has a vehicle sensor system 41 for capturing situation-specific information. For this purpose, the vehicle sensor system 41 could comprise, for example, video, radar and/or lidar sensors and possibly also inertial sensors. Furthermore, the EGO vehicle 31 also has access to information sources 42 outside the vehicle, such as GPS data, data from infrastructure sensors, or weather and road status data, traffic information, etc. All of these situation-specific data are combined in a perception module 43 to form an environment model of the example situation 30.

In order to decompose 50 the example situation 30 into partial situations, the environment model is first analyzed in order to identify in the example situation at least one of the partial situations pre-defined and stored in a database 51. For this purpose, the EGO vehicle 31 is first located on a map in order to extract the infrastructure elements surrounding the EGO vehicle 31—here the intersection with the intersection zone 32. This could be a standard definition (SD) card, as used in the context of navigation systems, or also a high definition (HD) card, which has a greater precision and is preferably used in conjunction with automated driving functions. The situation context is formed by information, such as traffic regulations taken from the map, the current weather situation, e.g. normal, strong rain, slippery conditions, fog, etc., which can be obtained via vehicle perception or from the Internet, as well as general models which describe the movement of road users. On the basis of this information, it is decided at system runtime how many instances of which partial situations are present. In the present example situation, the partial situation 61 “pedestrians at the crosswalk” is present once, while the partial situation 62 “further vehicle approaching the intersection zone from the west” is present twice. The instantiation conditions are stored in the database 51 together with the corresponding partial situation, either as program code, which performs the corresponding evaluations, or as a model of the instantiation condition, which can contain, for example, geometric operations, graph structures or even predictions of other road users. In general, instantiation conditions model properties of elements and/or combinations of elements of the situation context which must be given in a partial situation.

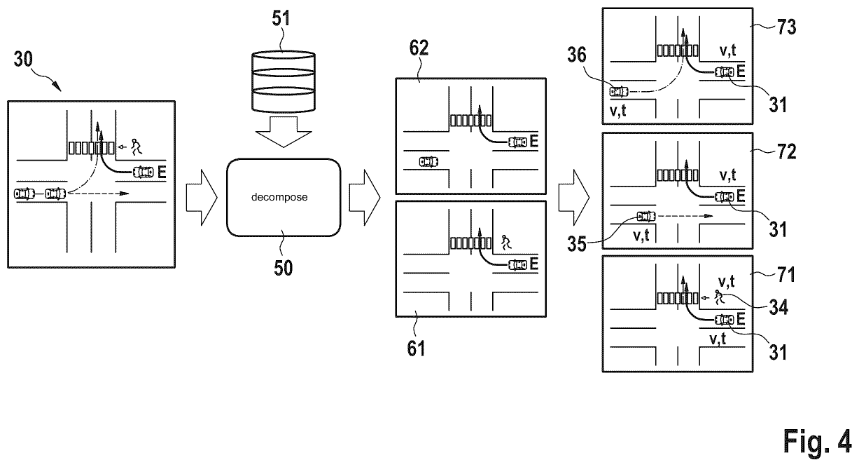

FIG. 4 illustrates the instantiation of the partial situations 61 and 62 identified in the example situation 30. In order to instantiate the partial situations 61 and 62, the template-like partial situations stored abstractly in the database 51 are data-loaded with the present situation-specific data of the example situation 30 and in this way specified according to the example situation 30. In the case of the partial situation 61 “pedestrians at the crosswalk”, this data-loading comprises—in addition to situation-specific information regarding the EGO vehicle 31, regarding the traffic infrastructure element 32 and regarding the general situation context—in particular situation-specific information regarding the pedestrian 34, such as position, speed, walking direction, etc. Further road users are not taken into account in the partial situation 61 and consequently not in the instance 71 of this partial situation 61 either. In the case of the partial situation 62 “further vehicle approaching the intersection zone from the west”, an instantiation 72 takes place for the vehicle 35 and a further instantiation 73 for the vehicle 36. In the loading of data into the partial situation 62, even these instantiations 72 and 73 in each case take into account only the EGO vehicle 31 and the one further vehicle 35 or 36, but no further road users.

FIG. 5 illustrates the analysis of the resulting instances 71, 72 and 73 as well as the determination of instance boundary conditions for the possible behaviors of the EGO vehicle 31 in the individual instances 71 as well as 72 and 73 of the partial situations 61 and 62.

All of the generated instances 71, 72 and 73 are evaluated individually and independently of one another, namely by using an evaluation model which is generated in advance for each partial situation 61 and 62 and is likewise stored in the database 51 together with the relevant partial situation. For the evaluation or analysis of the individual instances, information from the situation context relevant for the particular partial situation is again used. For the partial situation 61 “pedestrians at the crosswalk”, for example, the position of the pedestrian within the partial situation—in other words, on or before the crossing, for example—is relevant, since it can have effects on the planning decision. The evaluation models of the respective partial situations then provide a set of permitted behaviors for the EGO vehicle 31 in relation to their own situation context and without taking other partial situations into consideration.

In the exemplary embodiment described here, the evaluation models of the individual partial situations are based on the SOCA method. Accordingly, conflict zones between the two road users of the respective instances are described by Zwicky boxes in the traffic infrastructure element. The individual conflicts can be scored with a conflict severity.

In the case of the single instance 71 of the partial situation 61 “pedestrians at the crosswalk”, the presence and the position of a conflict zone depends on the position and speed of the EGO vehicle 31 and on the position and speed of the pedestrian 34 at the detection time t. In a first case constellation 711, the pedestrian 34 is so slow that the EGO vehicle 31 can still make the turn without endangering the pedestrian 34. In a second case constellation 712, the EGO vehicle 31 should not enter the intersection zone—conflict zone 81—but stop at the stop line. And in a third case constellation 713, the EGO vehicle 31 can indeed enter the intersection zone, but should then stop before the crosswalk stripes 33—conflict zone 82. The distinction between these different constellations is described in the SOCA method via a Zwicky box and modeled formally.

In the case of the instance 72 “straight ahead driver” in the partial situation 62 “further vehicle approaching the intersection zone from the west”, there is only one case constellation 721. In this case, no conflict occurs between the further vehicle 35 and the EGO vehicle 31.

In the case of the instance 73 “vehicle turning left” in the partial situation 62 “further vehicle approaching the intersection zone from the west”, there are two case constellations 731 and 732. In the first case constellation 731, the further vehicle 36 is so slow that the EGO vehicle 31 can still safely turn right before the left-turning vehicle 36. In the second case constellation 732, the EGO vehicle 31 should not enter the intersection zone—conflict zone 81—but stop at the stop line, even if it has priority over the left-turning vehicle 36, since the vehicle 36 has already initiated the turning process.

In each case, sets of instance boundary conditions for the possible behaviors of the EGO vehicle in the respective instances can be derived from the Zwicky boxes 81, 82. These instance boundary conditions are in each case based on the question: “What can happen and what is the consequence?”

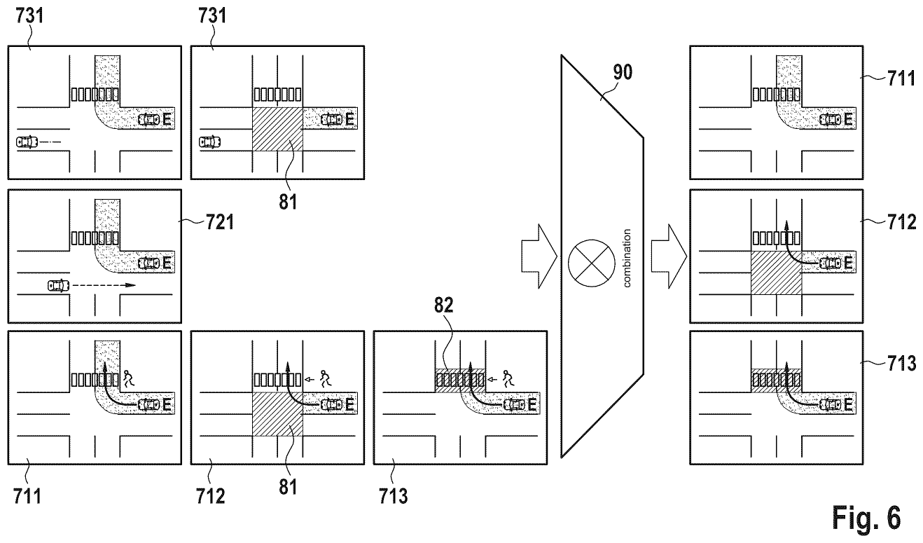

FIG. 6 illustrates the combination of the instance boundary conditions in order to determine boundary conditions for the possible behaviors of the EGO vehicle 31 in the example situation 30.

In the exemplary embodiment described here, the combination 90 of the ascertained instance boundary conditions consists simply in combining the instance boundary conditions. However, the combinations of the instance boundary conditions and thus the possible behaviors of the EGO vehicle 31 could also be thinned out, for example, by heuristics and rules which have already been applied in the evaluation models of the individual partial situations. In the present case, the possible behaviors remaining are 711=721=731; 712=732 and 713.

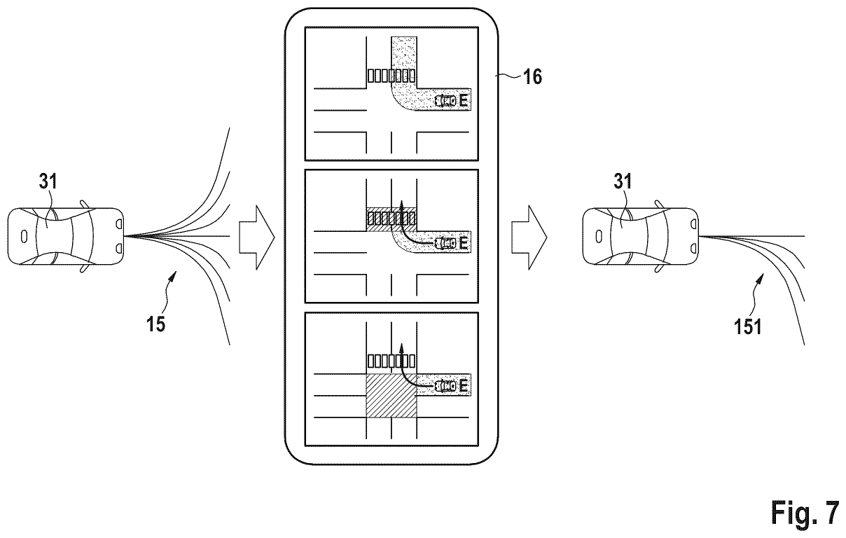

As already mentioned above, the possible behaviors of an EGO vehicle in a given situation can be described in different ways. For the prioritization according to the present invention, the possible behaviors are sufficiently determined by the boundary conditions that are ascertained by combining the instance boundary conditions. A detailing of the behaviors cannot be carried out until after the prioritization. However, it is also conceivable that already sampled trajectory candidates 15 are present. In this case, the boundary conditions ascertained for the possible behaviors of the EGO vehicle 31 can be used as a filter 16, which is illustrated by FIG. 7. Accordingly, the trajectory candidates 15 are compared with the ascertained boundary conditions. In this case, trajectory candidates which are not compatible with the boundary conditions are discarded. The result is an unsorted list of suitable trajectory candidates 151.

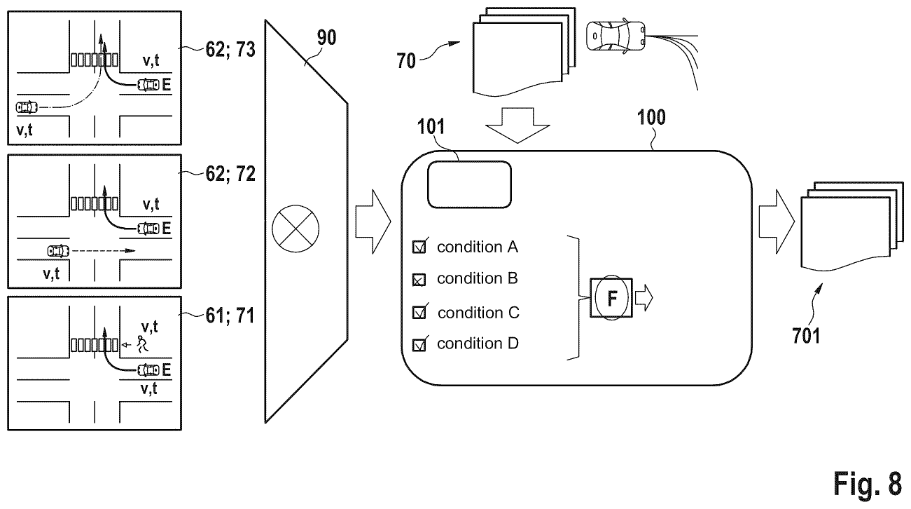

FIG. 8 illustrates a priority synthesis for the example situation 30 according to the method according to the present invention.

As already explained above in conjunction with FIGS. 5 and 6, within the context of the priority synthesis, the possible behaviors of the road users relevant to the driving decision of the EGO vehicle are first determined with the aid of partial situations 61; 62 and their instantiations 71; 72, 73. The combination 90 of these behaviors is thinned out by corresponding heuristics. The priority synthesis then evaluates the composition of the partial situations and, with the aid of a pre-defined rule set 100, determines the priority order. The rule set could advantageously use the same rules as the SOCA analysis of the partial situations in order to support the safety reasoning of the driving function. Some examples of such rules are listed below:
In intersection situations, boundary conditions from partial situations with pedestrians at the crosswalk are given higher priority than boundary conditions from partial situations with oncoming vehicles which would have to turn off left for there to be a conflict.
Boundary conditions from instances of partial situations which do not lead to conflicts with the EGO vehicle can be ignored, e.g. a pedestrian waiting at the crosswalk, an oncoming vehicle driving straight ahead.
Special situation: oncoming vehicle turns off and in this case infringes the traffic regulations
   Case 1: no pedestrian on the crosswalk→the behavior that stops and yields priority has the highest priority
   Case 2: pedestrian on crosswalk→the behavior which enters the intersection but stops before the crosswalk has priority. The EGO vehicle thus forms a buffer zone for the pedestrian and accepts bodywork damage in order to protect the life of the pedestrian. Since the EGO vehicle has priority, the turning vehicle is legally in the wrong.

To compare the ascertained boundary conditions for the possible behaviors of the EGO vehicle 31 with the rules of the rule set 100, the rule set 100 has a logic element 101 and a comparison function F which brings the individual initially unsorted behaviors 70 into an order 701 sorted by priorities. A basic assumption for the sorting is that the planning module must select behaviors that are allowed in all instances of partial situations present at the detection time. Conflicts, e.g. contradictory requirements due to different partial situations, are resolved with the aid of the rule set 100, so that a clear ranking 701 is created. Finally, the priority synthesis module sends, to a planning module, the generated behavior options of the EGO vehicle sorted by their priority; in this regard see FIG. 1.

Overall, with the aid of the rule set 100, a prioritization results for the exemplary embodiment described above, which prioritization is based, for example, on a safety reasoning for the automated driving function that was derived via the SOCA methodology. The rule set 100 can define exceptions for specific compositions of partial situations for the basic relationships described above. In addition, on the basis of this rule set and the evaluation of the different partial situations and the associated combinatoric system of behaviors, an absolute order of the behaviors of the EGO vehicle is established. On the basis of this order, the set of possible behaviors is sorted and passed to the planning module.

Automated vehicles have to find their way in complex situations that can change quickly and unexpectedly. Despite the greatest care, it can happen that an automated vehicle comes into a situation out of which it can no longer navigate while complying with all specified boundary conditions. In addition, situations can also occur in which requirements and boundary conditions contradict each other. In the literature, this is known as the falling crane problem [R. Benenson, T. Fraichard, M. Parent (2008)] and variants thereof. The method according to the present invention offers the possibility of prioritizing a set of possible behaviors of an automated vehicle in such a way that the automated vehicle, whenever possible, drives particularly efficiently and comfortably, while in the event of unexpected developments of a situation or in the case of impossible or contradictory requirements and boundary conditions, it can fall back on less preferred but still safe solutions which, however, can in any case be comprehensible and acceptable.

What is claimed is:

1. A computer-implemented method for behavior planning of an at least partially automated EGO vehicle using: (i) a database of pre-defined partial situations and at least one evaluation model for each of the partial situations, and (ii) a pre-defined rule set for evaluating possible behaviors of the EGO vehicle in a given situation, the method comprising the following steps performed by the EGO vehicle:
a. aggregating situation-specific information from the vehicle's own information sources and from information sources outside the vehicle;
b. generating an environment model of the given situation based on the situation-specific information;
c. analyzing the environment model to identify at least one partial situation in the database;
d. generating, using the situation-specific information, at least one instance for each respective identified partial situation;
e. analyzing all generated instances using the at least one evaluation model for the respective identified partial situation to determine boundary conditions for possible behaviors of the EGO vehicle in the given situation; and
f. prioritizing the possible behaviors of the EGO vehicle based on the determined boundary conditions in conjunction with the rule set.

2. The method according to claim 1, wherein each of the partial situations is defined as a situation class which is at least partially determined by at least one of the following elements:
the EGO vehicle,
at least one transport infrastructure element,
at least one other road user, and
a general situation context; and
wherein each of the partial situations can be instantiated by data-loading with situation-specific information.

3. The method according to claim 1, wherein the pre-defined partial situations of the database are selected such that an environment model generated based on situation-specific information can be represented by a composition of instantiated partial situations of the database.

4. The method according to claim 1, wherein at least some of the evaluation models are based on a decomposition of relevant partial situations into zone graphs and a morphological behavior analysis of road users involved.

5. The method according to claim 1, wherein at least some of the evaluation models include combination rules for combining relevant partial situation with further partial situations.

6. The method according to claim 1, wherein the pre-defined rule set includes and prioritizes safety requirements and/or traffic regulations and/or comfort requirements and/or vehicle-related boundary conditions.

7. The method according to claim 1, wherein each of the generated instance is analyzed separately to generate instance boundary conditions for the possible behaviors of the EGO vehicle for the generated instance, wherein the at least one evaluation model and a situation context of an underlying partial situation are used for the analysis.

8. The method according to claim 7, wherein at least some of the evaluation models include combination rules for combining relevant partial situation with further partial situations, and wherein the boundary conditions for the possible behaviors of the EGO vehicle are determined in the given situation by combining at least some of the generated instance boundary conditions, taking into account combination rules of underlying evaluation models.

9. The method according to claim 1, wherein the determined boundary conditions for the possible behaviors of the EGO vehicle are compared with the rules of the rule set, and the possible behaviors of the EGO vehicle are sorted by priorities based on the comparison.

10. The method according to claim 9, wherein the comparison of the boundary conditions for the possible behaviors of the EGO vehicle with the rules of the rule set is logged.

11. The method according to claim 1, wherein at least one of the possible behaviors of the EGO vehicle in the given situation is defined by:
at least some of the determined boundary conditions determined, or
a set of behavior instructions that implement at least some of the determined boundary conditions, or
a reference trajectory which satisfies at least some of the determined boundary conditions.

12. The method according to claim 1, wherein a possible behavior of the EGO vehicle to be implemented in the given situation is detailed and/or optimized with respect to a pre-specified quality function only after prioritization of behaviors previously determined as possible.

13. A computer-implemented system for behavior planning of an at least partially automated EGO vehicle, comprising:
a. a database of pre-defined partial situations and at least one evaluation model for each of the partial situations;
b. a perception module configured to aggregate situation-specific information from the vehicle's own information sources and from information sources outside the vehicle;
c. an evaluation module configured to generate an environment model based on of the situation-specific information;
d. a decomposition module configured to:
i. identify at least one partial situation in the database in the given situation by analysis of the environment model,
ii. generate at least one instance for each respective identified partial situation using the situation-specific information,
e. an analysis module configured to determine boundary conditions for possible behaviors of the EGO vehicle in the given situation by analyzing all generated instances using the at least one evaluation model of the respective identified partial situation; and
f. a pre-defined rule set for evaluating and prioritizing the possible behaviors based on the boundary conditions.
